(19) United States
(12) Patent Application Publication
(10) Pub. No.: US 2018/0057693 A1
(43) Pub. Date: Mar. 1, 2018

(54) Metallic Coatings with Improved Specular Response and Metameric Color Matching and Methods of Making the Same

(71) Applicant: Apple Inc., Cupertino, CA (US)

(72) Inventor: James R. Wilson, Cupertino, CA (US)

(21) Appl. No.: 15/372,110

(22) Filed: Dec. 7, 2016

Related U.S. Application Data
(60) Provisional application No. 62/380,528, filed on Aug. 29, 2016.

(51) Int. Cl. C09D 5/33; C09D 201/00; C09D 7/12

(52) U.S. Cl. CPC C09D 5/004; C08K 9/00; C09D 7/1291; C09D 201/00

(57) ABSTRACT

Metallic coatings containing metallic flakes with optical coatings are provided. The metallic flakes can be coated with multiple optical layers or a photonic crystal layer. The metallic flakes can also be coated with a pigment layer.

### CROSS-REFERENCE TO RELATED PATENT APPLICATION

This patent application claims the benefit of U.S. Patent Application No. 62/380,528, entitled “Metallic Coatings With Improved Specular Response, Metameric Color Matching and Methods of Making the Same,” filed on Aug. 29, 2016 under 35 U.S.C. §119(e), which is incorporated herein by reference in its entirety.

### FIELD

The described embodiments relate generally to optical coatings on metal flakes. More particularly, the present embodiments relate to improving metamerism between metallic surfaces and metallic coatings through optically coating metallic flakes.

### BACKGROUND

Coatings, such as inks or paints, that achieve metallic-looking finishes can use vacuum metallized aluminum flakes. The metalized aluminum flakes can effectively work like tiny mirrors dispensed in a clear resin or matrix. To appear metallic-looking, the level of specular sheen depends on the alignment of the flakes and the ability for light to reflect off the flakes unimpeded. For the application to achieve the greatest specular reflectance across visible wavelengths (300-800 nm), metal flakes should individually lay as flat as possible. For a collection of numerous flakes, the greatest reflectance, and hence greatest brightness, occurs when the flakes are collectively planar oriented to expose the greatest amount of surface area of the metallic flakes to the incident light and reflect as much of that light as possible.

In order to achieve colored metals such as rose gold, pigments are added to adjust the overall color. However, because dyes or pigments absorb light, adding them to a metallic coating tends to reduce the reflection effect of the metallic flakes, causing the metallic coating to have a reduced specular response (i.e. less light reflected) in comparison to the colored metal. When the colored metals and metallic coatings are used together for devices, the devices may have a non-uniform and/or non-reflective appearance.

Therefore, optically coating metallic flakes used in metallic coatings can provide for improved specular response to reduce metamerism and have an improved metallic-look.

### SUMMARY

In various aspects, the disclosure is directed to improved metal flake-based coatings containing thin metal flakes with good specular reflectance characteristics in the visible wavelength range of about 300 nm to about 800 nm.

In some instances, the metallic coating includes metallic flakes dispersed in a matrix with a first optical coating disposed on the metallic flakes having a first refractive index and a second optical coating disposed on the first optical coating having a second refractive index. In some embodiments, the first optical coating and the second optical coating are disposed on two sides of the metallic flakes. In some instances, a pigment layer can be further disposed on the metallic flakes.

In some instances, the metallic coating includes metallic flakes dispersed in a matrix with a photonic crystal coating disposed on the metallic flakes. The photonic crystal coating comprises particles suspended in an ordered array in a medium, wherein the particles have a different refractive index than the medium. In some embodiments, the photonic crystal coating is disposed on two sides of the metallic flakes. In some instances, a pigment layer can be further disposed on the metallic flakes.

In some instances, the metallic coating includes metallic flakes dispersed in a matrix, wherein the metallic flakes have a protective oxide layer and a pigment layer is disposed on the protective oxide layer. In some embodiments, the protective oxide layer is disposed on two sides of the metallic flakes and the pigment layer is disposed on two sides of the protective oxide layer.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A shows a cross-sectional view of a metallic flake with multiple layers of different optical coatings deposited thereon, in accordance with embodiments of the disclosure.

FIG. 1B shows a cross-sectional view of a beam of light impacting the surface of FIG. 1A and the light being reflected, in accordance with embodiments of the disclosure.

FIG. 1C shows a cross-sectional view of a metallic flake with multiple layers of different optical coatings deposited on two sides thereof, in accordance with embodiments of the disclosure.

FIG. 2A shows a cross-sectional view of a metallic flake with a pigment layer and multiple layers of different optical coatings deposited thereon, in accordance with embodiments of the disclosure.

FIG. 2B shows a cross-sectional view of a metallic flake with a pigment layer and multiple layers of different optical coatings deposited on two sides thereof, in accordance with embodiments of the disclosure.

FIG. 3A shows a cross-sectional view of a metallic flake with a photonic crystal coating deposited thereon, in accordance with embodiments of the disclosure.

FIG. 3B shows a cross-sectional view of a metallic flake with a photonic crystal coating deposited on two sides thereof, in accordance with embodiments of the disclosure.

FIG. 4A shows a cross-sectional view of a metallic flake with a pigment layer and photonic crystal coating deposited thereon, in accordance with embodiments of the disclosure.

FIG. 4B shows a cross-sectional view of a metallic flake with a pigment layer and photonic crystal coating deposited on two sides thereof, in accordance with embodiments of the disclosure.

FIG. 5A shows a cross-sectional view of a metallic flake with a protective oxide layer and a pigment layer deposited thereon, in accordance with embodiments of the disclosure.

FIG. 5B shows a cross-sectional view of a metallic flake with a protective oxide layer and a pigment layer deposited on two sides thereof, in accordance with embodiments of the disclosure.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The disclosure relates to metallic flake-based coatings (including paints, inks or other layers that can be applied to surfaces) having improved specular response and metameric color matching. According to embodiments of the disclosure, optically coated metallic flake-based coatings and methods of making such are provided. In some embodiment, the metallic flakes are coated with multiple layers of optical coatings. In other embodiments, the metallic flakes are coated with a photonic crystal layer. In still other embodiments, the metallic flakes are anodized, then dyed.

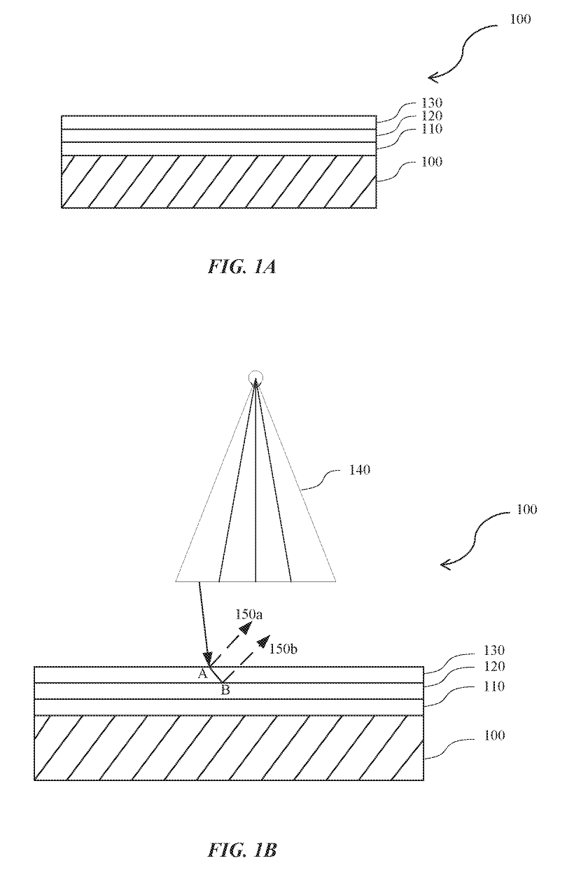

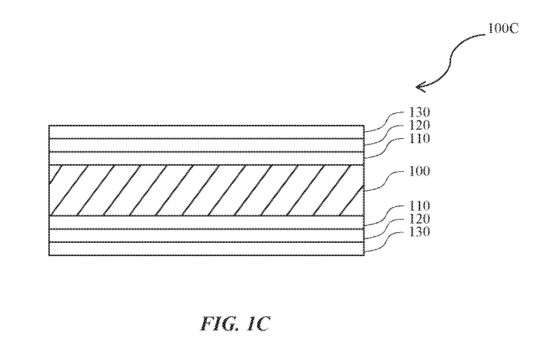

These and other embodiments are discussed below with reference to FIGS. 1A-5. However, those skilled in the art will readily appreciate that the detailed description given herein with respect to these Figures is for explanatory purposes only and should not be construed as limiting.

Typically, metallic coatings that have metal-like finishes use vacuum metallized aluminum flakes that work like little mirrors dispersed in a clear resin or matrix. The level of specular sheen of the metallic coatings depends on alignment of the metallic flakes and the ability of the light to be reflected off the flakes. In order to achieve colored metals, such as gold, other dyes or pigments are added to adjust the overall color. However, because dyes and pigments absorb light, the addition of dyes and/or pigments to metallic coatings can reduce the reflection effect of the metallic flakes contained therein. As such, the specular response of the metallic coatings can be reduced such that it appears more matte (sometime referred to as dead) in comparison to a metal surface. Therefore, embodiments of the disclosure are directed to metallic flake based coatings having improved specular response and metameric color matching to metals. The metallic coatings of the disclosure can include inks, paints, or other layers that can be applied to surfaces. In such embodiments, coatings or layers are applied to the metallic flakes to adjust the specular response of the metallic flakes, thereby altering the specular response of the metallic coating.

### Multilayer Optical Coatings

Referring to FIG. 1A, an exemplary metallic flake 100 coated with multiple layers of optical coatings 110, 120, and 130 is shown.

The metallic flake 100 with multiple layers of optical coatings 110, 120, and 130 uses optical interference to change the visual appearance of the metallic flake. Optical coatings 110, 120, and 130 can be different or the same. The multiple layers of optical coatings reflect back different waves of light and can optically interact with each other to create an optical effect that can improve the specular response (e.g., sheen) and metameric color matching of the metallic coatings. For example, in some embodiments, the multiple layers of optical coatings may create the optical effect through reflection such that when the metallic flake 100 is incorporated into a coating, the metallic flake can appear metal-like.

The optical coatings 110, 120, and 130 can be selected to design an exact color (e.g. rose gold) as well as a specular sheen. When light is incident on metallic flake 100, optical coatings 110, 120 and 130 each reflect back a different wavelength. The optical coatings can have optically constructive or destructive interference to reflect a particular wavelength associated with a specific color. The reflected wavelength can be different from the surface to which the metallic coating containing the optically coated metallic flakes is applied.

The specific optical effects created can be designed by selection of the number of layers of optical coatings, the thickness of the optical coatings, and/or the refractive index of each optical coating. The number of layers of optical coatings, thickness of the layers of optical coatings, and the refractive index of the layers of the optical coatings can affect the specular sheen and can be selected to obtain a specular response. For example, the multiple layers of optical coatings can be selected such that a surface appears as a specific metal (e.g. aluminum, rose gold, yellow) regardless of the viewing angles or contours of the surface.

As shown in FIG. 1A, the metallic flake 100 includes multiple layers of optical coatings 110, 120, and 130. The metallic flake can be aluminum, titanium, copper, gold, platinum, or any other suitable metal. The metallic flake 100 can have any shape. The metallic flakes can be of a uniform shape or varying shapes. Nevertheless, for purposes of consistency, the size of the flake will be referred to as having a “diameter.” In some embodiment, the average diameter of the flakes is in a range of about 1-50 microns, and while in others the average diameter of the flakes is in a range of about 5-25 microns. In some embodiments, the average flake diameter is at least one micron. In some embodiments, the average flake diameter is at least 5 microns. In some embodiments, the average flake diameter is at least 10 microns. In some embodiments, the average flake diameter is at least 15 microns. In some embodiments, the average flake diameter is at least 20 microns. In some embodiments, the average flake diameter is at least 25 microns. In some embodiments, the average flake diameter is at least 30 microns.

In some embodiments, the average flake diameter is less than or equal to 75 microns. In some embodiments, the average flake diameter is less than or equal to 70 microns. In some embodiments, the average flake diameter is less than or equal to 65 microns. In some embodiments, the average flake diameter is less than or equal to 60 microns. In some embodiments, the average flake diameter is less than or equal to 55 microns. In some embodiments, the average flake diameter is less than or equal to 50 microns. In some embodiments, the average flake diameter is less than or equal to 45 microns. In some embodiments, the average flake diameter is less than or equal to 40 microns. In some embodiments, the average flake diameter is less than or equal to 35 microns. In some embodiments, the average flake diameter is less than or equal to 30 microns.

In some embodiments, the thicknesses of the flakes are in a range of about 1 nm to 10 microns. In some embodiments, the thicknesses of the flakes are from 10 nm to 1 micron.

The optical coatings 110, 120 and 130 can have different refractive indices. In some embodiments, the multiple layers may include an optical coating with a low refractive index and an optical coating with a high refractive index. In some embodiments, the metallic flake with a multilayer optical coating can include a first optical coating having a first refractive index and a second optical coating having a second refractive index. The first refractive index can be lower than the second refractive index. In other embodiments, the first refractive index can be higher than the second refractive index.

Although the exemplary metallic flake 100 of FIGS. 1A and 1B are depicted as having three layers of optical coatings, this is for illustrative purposes only and not intended to be limiting. In other embodiments, any number of different optical coatings can be used from two layers or more. By changing the number of layers, the combined optical effect of the waves of light reflected from each of the optical coating changes thereby adjusting the specular response of metallic flake 100.

Layers of optical coatings 110, 120 and 130 can have any thickness. In some instances, the thicknesses of the optical coatings will be less than 1 micron. Generally, the thickness of the optical coatings will be in the nanometer scale. In some embodiments, the thicknesses of the optical coatings can range from 50-800 nm, while in other embodiments the thicknesses of the optical coatings can range from 100-200 nm. In some embodiments, each optical coating layer may have the same thickness, while in other embodiments, the optical coating layers can have different thicknesses. In some embodiments, some optical coating layers may have the same thickness while other optical coating layers are different. In some embodiments, the thickness of the optical coatings are selected to be a quarter wavelength of the light that is selected to be reflected. For example, if the selected wavelength of light to be reflected is 500 nm, the thickness of an optical coating layer can be ¼ of 500 nm (i.e. 125 nm).

By way of example, without intending to be limiting, if the metallic coating appears as a particular colored metal (e.g. blue) associated with a particular wavelength of light (e.g. 490 nm), then the optical coating can be designed to transmit (e.g. reflect) back that particular wavelength such that it appears as the selected color. In such instances, using the quarter wavelength principle, the thickness of the optical layer is a quarter of 490 nm (e.g. 122.5 nm).

The thickness of the optical coatings 110, 120 and 130 can affect the visual appearance of the metallic flake, and ultimately the metallic coating, through thin-film interference. Thin-film interference occurs when incident light waves that are reflected by the upper and lower boundaries of a thin film (e.g., an optical coating) interfere with one another to form a new wave. The degree of constructive or destructive interference between the two light waves depends on the difference in their phase. This difference in part depends on the thickness of the optical coating, as seen in FIG. 1B.

As illustrated in FIG. 1B, beam of light 140 is incident to metallic flake 100. As the light beam 140 travels, it impacts metallic flake 100 at point A on the upper boundary of optical coating 130 and a portion of the light is reflected as wave 150a, while another portion of the light continues to travel through optical coating 130 to the lower boundary. At point B of the lower boundary, another portion of the light is reflected as wave 150b. Reflected waves 150a and 150b can interfere with each other. The degree of constructive or destructive interference between waves 150a and 150b will depend on the difference in their phases. Their phase differences can depend on the thicknesses of the optical coating, which has an impact on the optical path of the reflected waves.

By changing the thickness of an optical coating, the optical paths of the reflected waves from the upper and lower boundaries of a coating change and the difference between the optical paths (as referred to as the optical path difference or OPD) can be increased or decreased to affect the degree of interference. For example, without intending to be limiting, if the thickness of optical coating 130 is changed, the optical paths of the reflected waves from the upper and lower boundaries of optical coating 130 are changed and result in a different OPD and determine the degree of interference. The thickness of any of optical coatings 110, 120 or 130 can be changed.

Additionally, the specular response of the metallic flake can be altered by changing the thicknesses of the different optical coatings, alone or in combination. For example, without intending to be limiting, if the thickness of optical coating 120 was altered (i.e., increased or decreased) the optical effect created through the interference of the reflected or transmitted wave interacting with the reflected or transmitted light wave from optical coating 130 can change, thereby altering the specular response of metallic flake 100.

The multiple layers of different optical coatings can be deposited on the metallic flake using any known layer deposition technique. In some embodiments, the optical coatings may be deposited using sputtering, vapor deposition (chemical or physical), spraying, dip coating, laminating, or other suitable deposition methods. While optical coatings 110, 120, and 130 are depicted in FIGS. 1A and 1B as being on surface (or side) of metallic flake 100, this is for illustrative purposes only. The optical coatings 110, 120, and 130 can deposited on multiple surfaces (or sides) of the metallic flake 100, as shown in FIG. 1C. As illustrated, optical coatings 110, 120, and 130 are deposited on two side of metallic flake 100C. By applying the optical coatings 110, 120 and 130 to multiple surfaces of the metallic flake, the dependence of the specular response (i.e. the ability to reflect light) on the alignment of the metallic flake within a metallic coating is reduced. In other words, the ability of the metallic flakes to reflect light is unimpeded and not alignment dependent. In some embodiments, metallic flake may be encapsulated within optical coatings 110, 120, and 130.

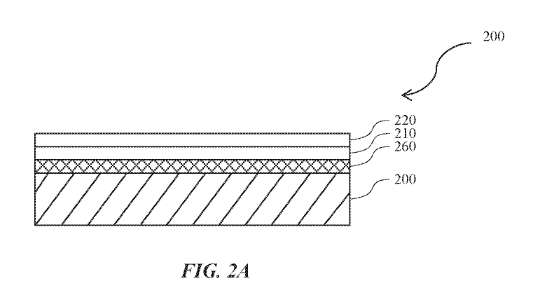

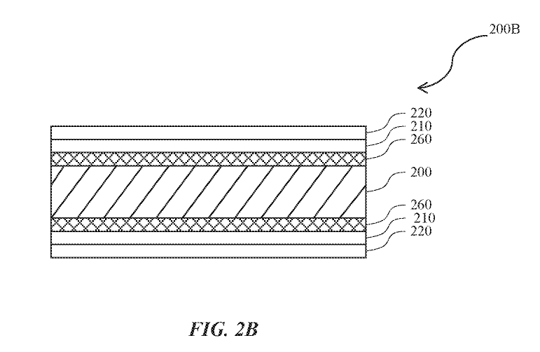

In some embodiments, the metallic flake can also be dyed or have a pigment layer. In such instances, as illustrated in FIG. 2A, a pigment layer 260 can be deposited on metallic flake 200 and then optical coatings 210 and 220 can be deposited upon the pigment layer 260. In some instances, the pigment layer 260 can be selected such that the metallic coating has the look of a selected type of metal (e.g. copper, aluminum, yellow gold, rose gold, white gold, platinum, titanium, etc.) By way of illustration, without intending to be limiting, a metal can be used for housings, cases, frames, etc., for devices. The devices can also have regions in which metallic coatings are applied to surfaces of the device and it may be desire that these regions have metameric color matching as well as specular response in comparison to the metal. The pigment layer 260 can be added to color match the metal of the housing, case, frame, etc. of the device, while the multiple layers of optical coatings 210 and 220 reflects the light such that the desire specular response is achieved.

While optical coatings 210 and 220 and pigment layer 260 are depicted in FIG. 2A as being on surface (or side) of metallic flake 200, this is for illustrative purposes only. The optical coatings 210 and 220 and pigment layer 260 can deposited on multiple surfaces (or sides) of the metallic flake 200, as shown in FIG. 2B. As illustrated, optical coatings 210 and 220 and pigment layer 260 are deposited on two side of metallic flake 200B. By applying the optical coatings 210 and 220 and pigment layer 260 to multiple surfaces of the metallic flake, the dependence of the specular response (i.e. the ability to reflect light) on the alignment of the metallic flake within a metallic coating is reduced. In other words, the ability of the metallic flakes to reflect light is unimpeded and not alignment dependent.

In some embodiments, the metallic flakes 100 and 200 can be made by applying the multiple layers of optical coatings to a metal thin film. Similarly, pigment layer 260 can be applied to a metal thin film layer. As explained above, the optical coatings as well as the pigment layer can be applied to multiple surfaces (or sides). As such, the optical coatings and/or pigment layer can be deposited on a top surface and bottom surface of the metal thin film to encapsulate the metal thin film. Then, the metal thin film can be broken apart to form metallic flakes 100 and 200 such that the metallic flakes are coated on at least two sides and the specular response of a coating containing the coated metallic flakes is independent of alignment.

Metallic flakes 100 and 200 with the multiple layers of optical coatings can be dispersed in a clear/transparent resin or matrix, which can be applied as a metallic coating to surfaces of a substrate. Substrate may be formed of a transparent or semitransparent material. In other embodiments the substrate may be opaque. In some embodiments, substrate can be a glass, a metallic glass, a polymer or plastic, or other suitable material.

### Photonic Crystal Coating

In other embodiments, metallic flake based coatings can have improved specular response and metameric color matching to metals by adding a photonic crystal coating to the metallic flakes. In such instances, the specular response and/or metameric color matching can be adjusted by creating metallic flakes having a photonic crystal coating. The photonic crystal coating includes colloidal or suspended particles with a periodic pattern in matrix. Specific specular responses can be designed by selection of the particle size, the particle shape, the order (i.e. periodicity) of the particles, and index of refraction of the particles, as well as the index of refraction of the matrix of the photonic crystal coating. For example, in some embodiments, the colloidal or suspended particles in the matrix of the photonic crystal coating can be designed to have a particular specular response independent of the viewing angle and/or the incident light source.

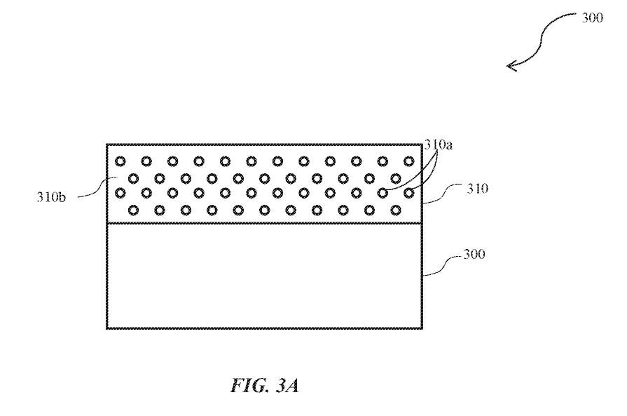

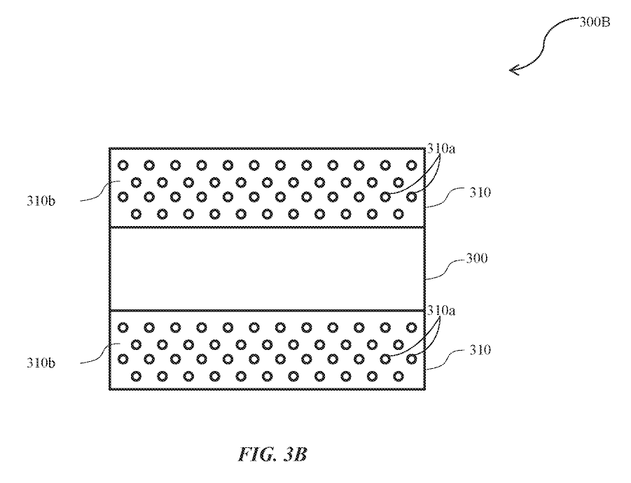

As shown in FIG. 3A, a metallic flake 300 can include a photonic crystal coating 310 with an ordered array of suspended particles 310a dispersed in matrix 310b. In particular, the photonic crystal coating 310 includes particles 310a suspended in matrix 310b. The selection of the particle material, particle size, the particle shape, the order (i.e. periodicity) of the particles, and index of refraction of the particles, as well as the index of refraction of the matrix of the particle coating can be used to change the specular response (i.e. the ability to reflect light) of the metallic flake.

Like metallic flake 100 or 200, the metallic flake 300 can be aluminum, titanium, copper, gold, platinum, or any other suitable metal. The metallic flake 300 can have any shape. The metallic flakes can be of a uniform shape or varying shapes. In some embodiments, the diameters of the metallic flakes can be from 10 nm to 10 microns. In some embodiments, the diameter of the metallic flakes can be from 10 nm to 1 micron. In other embodiments, the diameter of the metallic flakes can be from 10 nm to 100 nm. In some embodiments, the thicknesses of the flakes can be from 100 nm to 10 microns.

In some embodiments, the specular response of the metallic flake 300 can be designed by altering the index of refraction of the matrix and/or particles. Particles 310a and matrix 310b are different materials that have different refractive indices. In some embodiments, matrix 310b may be a polymer; the polymer may be an elastomeric material, such as a polymeric elastomer. In other embodiments, the matrix may be a silicon-containing polymer, polyacrylamide, polyethylene oxide, polyethylene glycol diacrylate, polypropylene glycol diacrylate, polyvinyl alcohol, polyacrylate or a copolymer thereof. Other materials for the matrix are possible.

In some embodiments, particles 310a can be a ceramic (e.g., silica, alumina, etc.), an organic material (e.g., polymer, acrylic, etc.), or any other suitable material. In some embodiments, the particles 310a will be the same material, while in other embodiments, the particles 310a can be a combination of two or more different materials.

In some embodiments, the specular response of the metallic flake can be affected by selection of the ordered arrangement of the particles 310a with in the matrix 310b. When particles 310a are suspended within matrix 310b in an ordered array, photonic bans form such that certain wavelengths of light can be reflected or transmitted, thereby creating a specific specular response. Particles 310a can be disposed within matrix 310b in any ordered (periodic) arrangement to create the specific specular response.

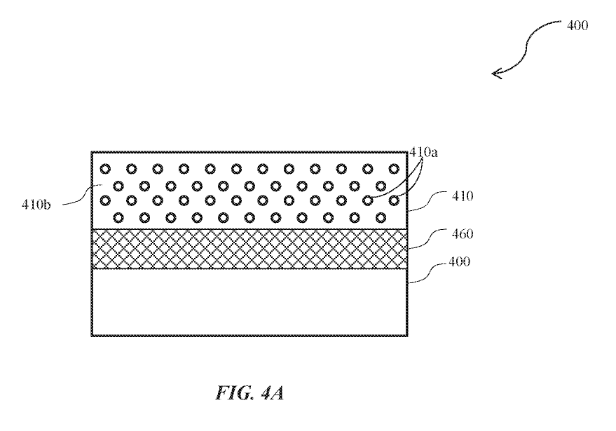

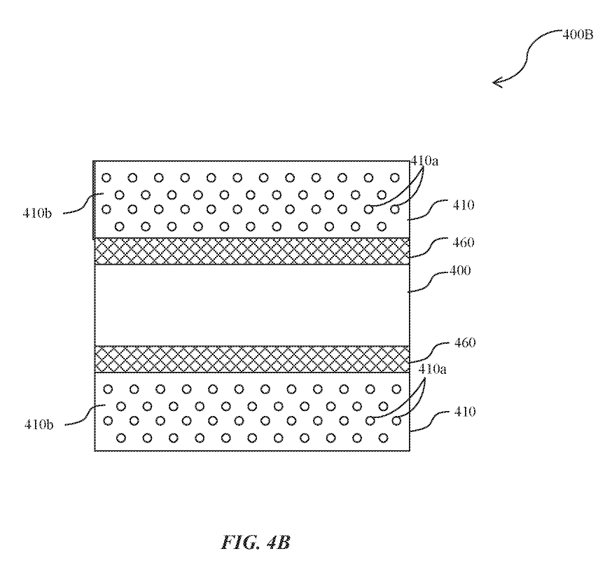

In some embodiments, the metallic flake can also be dyed or have a pigment layer along with the photonic crystal coating. In such instances, as illustrated in FIG. 4A, a pigment layer 460 can be deposited on metallic flake 400 and then photonic crystal coating 410 can be deposited upon the pigment layer 460. In some instances, the pigment layer 460 can be selected such that the metallic coating has the look of a selected type of metal (e.g. copper, aluminum, yellow gold, rose gold, white gold, platinum, titanium, etc.) By way of illustration, without intending to be limiting, a metal can be used for housings, cases, frames, etc., for devices. The devices can also have regions in which metallic coatings are applied to surfaces of the device and it may be desire that these regions have metameric color matching as well as specular response in comparison to the metal. The pigment layer 460 can be added to color match the metal of the housing, case, frame, etc. of the device, while the photonic crystal coating reflects the light such that the desire specular response is achieved.

The photonic crystal coatings 310 and 410 along with pigment layer 460 can be deposited on the metallic flake using any known layer deposition technique. In some embodiments, the optical coatings may be deposited using sputtering, vapor deposition (chemical or physical), spraying, dip coating, laminating, or other suitable deposition methods.

While photonic crystal coatings 310 and 410, along with pigment layer 460, are depicted in FIGS. 3 and 4 as being on one surface (or side) of metallic flake 300 or 400, this is for illustrative purposes only. The photonic crystal coatings 310 and 410, along with pigment layer 460, can deposited on multiple surfaces (or sides) of the metallic flake 300 or 400. For example, as shown in FIG. 3B, photonic crystal coating 310 is deposited on two side of metallic flake 300B. Similarly, as shown in FIG. 4B, the photonic crystal coating 410 and pigment layer 460 are deposited on two side of the metallic flake 400B. In some embodiments, metallic flake may be encapsulated within photonic crystal coatings 310 and 410, along with pigment layer 460. By applying the photonic crystal coatings 310 and 410, along with pigment layer 460, to multiple surfaces of the metallic flake, the dependence of the specular response (i.e. the ability to reflect light) on the alignment of the metallic flake within a metallic coating is reduced. In other words, the ability of the metallic flakes to reflect light is unimpeded and not alignment dependent.

In some embodiments, the metallic flakes 300 and 400 can be made by applying the multiple layers of optical coatings to a metal thin film. Similarly, pigment layer 460 can be applied to a metal thin film layer. As explained above, the photonic crystal coating as well as the pigment layer can be applied to multiple surfaces (or sides). As such, the photonic crystal coating and/or pigment layer can be deposited on a top surface and bottom surface of the metal thin film to encapsulate the metal thin film. Then, the metal thin film can be broken apart to form metallic flakes 300 and 400 such that the metallic flakes are coated on at least two sides and the specular response of an ink, paint, or coating containing the coated metallic flakes is independent of alignment.

Like metallic flakes 100 and 200 with the multiple layers of optical coatings, metallic flakes 300 and 400 with photonic crystal coatings can be dispersed in a clear/transparent resin or matrix, which can be applied as a metallic coating to surfaces of a substrate.

### Dyed and Anodized Metallic Flakes

In still other embodiments, the metallic flakes can be dyed and anodized and then incorporated into coatings. Dying and anodizing the metallic flakes can improve specular sheen and color matching of the coatings to metal surfaces (i.e. improving metameric matching).

Typically, metallic coatings that have metal-like finishes use vacuum metallized aluminum flakes that work like little mirrors dispersed in a clear resin or matrix. The level of specular sheen of the metallic coatings depends on alignment of the metallic flakes and the ability of the light to be reflected off the flakes. These metallic coatings are made, in some instances, to color match dyed anodized aluminum, which can be used for housings, cases, frames, etc., for devices. In order to color match the dyed anodized aluminum, dyes or pigments are added to the metallic coatings. By way of illustration, without intending to be limiting, anodized aluminum can be made into housings, cases, frames, etc., for devices and dyed to have a particular color (e.g., blue anodized aluminum). The devices can also have regions in which metallic coatings are applied to surfaces of the device and it may be desire that these regions have metameric matching to the dyed anodized aluminum.

However, the dyes or pigments have an inherently different metameric response to different lighting conditions compared to the dyes or pigments used to color the anodized aluminum. As such, there can be challenges in having metameric color matching of the metallic coatings.

In such instances, the dye used to color the anodized aluminum (or other metal) can be incorporated into the metallic flakes themselves, such that the specular response of the dyed metallic flakes will have improve color matching to the anodized aluminum independent of different lighting conditions. In some embodiments, a dying step can be added to a vacuum metallized flake process.

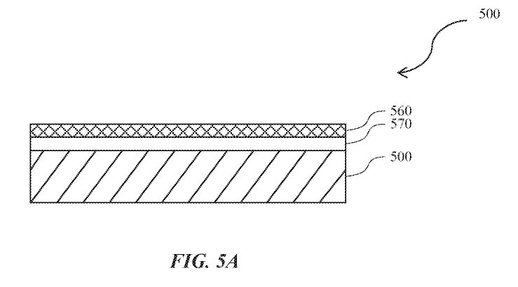

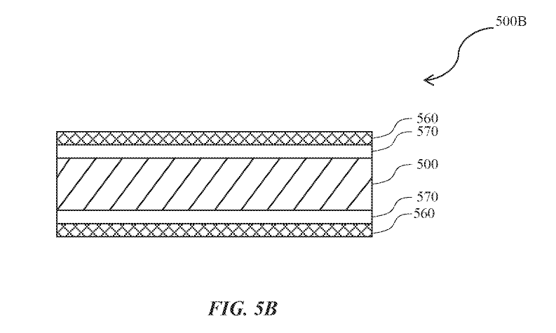

As shown in FIG. 5A, a metallic flake 500 can be anodized such that it has a porous protective oxide layer 570. The porous protective oxide layer 570 can be made via any conventional anodization process, for example an electrolytic process. After anodizing, the metallic flake can be coated with a dye or pigment. The dye or pigment can penetrate the porous protective oxide layer 570. The dye or pigment can then be sealed in the protective oxide layer 570 in a separate anodization step. The dye or pigment is thereby protected from the external environment.

In some embodiments, the dyed and anodized metallic flakes can be made by anodizing a metal thin film. Then the dye or pigment can be applied to the anodized metal thin film, and the metal thin film can be broken apart to form metallic flakes 500.

While the protective oxide layer 570 that incorporates a dye or pigment is depicted in FIG. 5A as being on one surface (or side) of metallic flake 500, this is for illustrative purposes only. The protective oxide layer 570 that incorporates a dye or pigment can be deposited on multiple surfaces (or sides) of the metallic flake 500, as shown in FIG. 5B. By applying the protective oxide layers 570a and 570b to metallic flake 500 and incorporating a dye or pigment to multiple surfaces of the metallic flake, the dependence of the specular response (i.e. the ability to reflect light) on the alignment of the metallic flake within a metallic coating is reduced. In other words, the ability of the metallic flakes to reflect light is unimpeded and not alignment dependent.

Like metallic flakes 100-400 with the multiple layers of optical coatings or photonic crystal coating, dyed and anodized metallic flakes 500 can be dispersed in a clear/transparent resin or matrix, which can be applied as a metallic coating to surfaces of a substrate.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not target to be exhaustive or to limit the embodiments to the precise forms disclosed. It will be apparent to one of ordinary skill in the art that many modifications and variations are possible in view of the above teachings.

What is claimed is:

1. A metallic coating, comprising:
metallic flakes dispersed in a matrix,
a first optical coating disposed on the metallic flakes having a first refractive index; and
a second optical coating disposed on the first optical coating having a second refractive index.

2. The metallic coating of claim 1, wherein the first refractive index is lower than the second refractive index.

3. The metallic coating of claim 1, wherein the first optical coating is disposed on a two sides of the metallic flakes.

4. The metallic coating of claim 1 further comprising a pigment layer, wherein the pigment layer is disposed between the metallic flakes and the first optical coating.

5. The metallic coating of claim 1, wherein the metallic flakes are aluminum.

6. The metallic coating of claim 1, wherein the first optical coating and second optical coating have thicknesses of less than 1 micron.

7. The metallic coating of claim 1, wherein the first optical coating and second optical coating have thicknesses ranging from 100-200 nm.

8. The metallic coating of claim 1, wherein the metallic coating is deposited on a surface of a substrate.

9. The metallic coating of claim 8, wherein the substrate is a glass.

10. A metallic coating, comprising:
metallic flakes dispersed in a matrix,
a photonic crystal coating disposed on the metallic flakes, the photonic crystal coating comprises particles suspended in an ordered array in a medium, the particles have a different refractive index than the medium.

11. The A metallic coating of claim 10, wherein the particles comprise two or more different materials.

12. The metallic coating of claim 10, further comprising a pigment layer disposed between the metallic flakes and the photonic crystal coating.

13. The metallic coating of claim 10, wherein the photonic crystal coating is disposed on two sides of the metallic flakes.

14. The metallic coating of claim 10, wherein the metallic coating is deposited on a surface of a substrate.

15. The metallic coating of claim 14, wherein the substrate is a glass.

16. A metallic coating comprising:
metallic flakes dispersed in a matrix, each of the metallic flakes comprise a protective oxide layer, and a dye or pigment embedded in the protective oxide layer.

17. The metallic coating of claim 16, wherein the metallic flakes comprise a protective oxide layer on two sides of each of the metallic flakes, and a dye or pigment is embedded in the two sides of each of the metallic flakes.

18. The metallic coating of claim 16, wherein the metallic flakes are aluminum.

19. The metallic coating of claim 16, wherein the metallic coating is deposited on a surface of a substrate.

20. The metallic coating of claim 19, wherein the substrate is a glass.
